(19) United States
(12) Patent Application Publication
(10) Pub. No.: US 2017/0307393 A1
(43) Pub. Date: Oct. 26, 2017

(54) INFORMATION PROCESSING APPARATUS, INFORMATION PROCESSING METHOD, AND PROGRAM

(71) Applicant: SONY CORPORATION, Tokyo (JP)

(72) Inventors: Yoshiyuki KOBAYASHI, Tokyo (JP); Masatomo KURATA, Tokyo (JP); Tomohisa TAKAOKA, Kanagawa (JP)

(73) Assignee: SONY CORPORATION, Tokyo (JP)

(21) Appl. No.: 15/518,327

(22) PCT Filed: Oct. 27, 2015
(86) PCT No.: PCT/JP2015/080290

§ 371 Date: Apr. 11, 2017

(30) Foreign Application Priority Data
Dec. 17, 2014 (JP) 2014-255037

(51) Int. Cl. G01C 21/36; G01C 21/10; G01C 21/26; G01S 5/02

(52) U.S. Cl. CPC G01C 21/362; G01S 5/02; G01C 21/10; G01C 21/26

(57) ABSTRACT

[Object] To accurately estimate a user's position on the basis of sensor data by preparing absolute criteria in advance.

[Solution] Provided is an information processing apparatus including: a feature extractor configured to extract a feature of first sensor data provided by a sensor carried or worn by a user; a matching unit configured to match the feature of the first sensor data and a feature of second sensor data corresponding to the first sensor data, the feature of the second sensor data being associated with given position information; and a position estimation unit configured to estimate a position of the user on the basis of a result of the matching.

### TECHNICAL FIELD

The present disclosure relates to an information processing apparatus, an information processing method, and a program.

### BACKGROUND ART

Global navigation satellite systems (GNSSs), typified by the Global Positioning System (GPS), have been widely used in methods for detecting a user's position. However, in a GNSS, sufficient position detection accuracy is not always acquired indoors or in a built-up area where it is difficult to receive radio waves from satellites. In such cases, it is possible to employ a method of estimating a user's position, for example, on the basis of communicable access points of Wi-Fi or the like and the strengths of radio waves from the access points. However, it is difficult for this method to improve the accuracy since access points, the locations of which have been specified, are limited or the strength of radio waves is affected by various emotional conditions. A technology for autonomous positioning used as a solution to these cases is described in Patent Literature 1.

### CITATION LIST

### Patent Literature

Patent Literature JP 2013-210300A

### DISCLOSURE OF INVENTION

### Technical Problem

Although the autonomous positioning technology described in Patent Literature 1 is applicable to a wide variety of cases, the technology is limited, for example, in accuracy improvement through removal of the influence of errors due to individual movement variations of users or the way of carrying or wearing terminal devices. In addition, there is a possibility that the influence of errors cumulatively increases since relative positioning is performed. Therefore, for example, there is demand for a technology that accurately estimates the user's position on the basis of absolute criteria in the case where it is difficult to employ positioning using the GNSS or access points as described above.

Therefore, the present disclosure suggests an improved and novel information processing apparatus, information processing method, and program, which make it possible to accurately estimate the user's position on the basis of sensor data by preparing absolute criteria in advance.

### Solution to Problem

According to the present disclosure, there is provided an information processing apparatus including: a feature extractor configured to extract a feature of first sensor data provided by a sensor carried or worn by a user; a matching unit configured to match the feature of the first sensor data and a feature of second sensor data corresponding to the first sensor data, the feature of the second sensor data being associated with given position information; and a position estimation unit configured to estimate a position of the user on the basis of a result of the matching,

According to the present disclosure, there is provided an information processing method including: extracting a feature of first sensor data provided by a sensor carried or worn by a user; matching the feature of the first sensor data and a feature of second sensor data corresponding to the first sensor data, the feature of the second sensor data being associated with given position information; and estimating a position of the user on the basis of a result of the matching.

According to the present disclosure, there is provided a program allowing a processing circuit to realize: a function to extract a feature of first sensor data provided by a sensor carried or worn by a user; a function to match the feature of the first sensor data and a feature of second sensor data corresponding to the first sensor data, the feature of the second sensor data being associated with given position information; and a function to estimate a position of the user on the basis of a result of the matching.

### Advantageous Effects of Invention

According to the present disclosure described above, absolute criteria are prepared in advance, making it possible to accurately estimate the user's position on the basis of sensor data.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a block diagram illustrating an exemplary overall configuration of an embodiment of the present disclosure.

FIG. 2A is a block diagram illustrating another exemplary overall configuration of the embodiment of the present disclosure.

FIG. 2B is a block diagram illustrating another exemplary overall configuration of the embodiment of the present disclosure.

FIG. 3 is a schematic block diagram illustrating a first example of a functional configuration of an input unit, a processing unit, and an output unit according to an embodiment of the present disclosure.

FIG. 4 is a schematic block diagram illustrating a second example of a functional configuration of an input unit, a processing unit, and an output unit according to an embodiment of the present disclosure.

FIG. 5 is a diagram for explaining an overview of map learning and position estimation according to an embodiment of the present disclosure.

FIG. 6 is a diagram for explaining an exemplary probability model used in an embodiment of the present disclosure.

FIG. 7 is a view illustrating an exemplary sensor map generated in an embodiment of the present disclosure.

FIG. 8 is a block diagram illustrating a first example of a system configuration according to an embodiment of the present disclosure.

FIG. 9 is a block diagram illustrating a second example of a system configuration according to an embodiment of the present disclosure.

FIG. 10 is a block diagram illustrating a third example of a system configuration according to an embodiment of the present disclosure.

FIG. 11 is a block diagram illustrating a fourth example of a system configuration according to an embodiment of the present disclosure.

FIG. 12 is a block diagram illustrating an exemplary hardware configuration of an information processing apparatus according to an embodiment of the present disclosure.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

The description will be given in the following order.

1. Overall configuration
1-1. Input unit
1-2. Processing unit
1-3. Output unit
2. Exemplary functional configuration
2-1. When position estimation is performed
2-2. When map learning is performed
3. Principle of map learning and position estimation

### 4. Implementation

5. System configuration
6. Hardware configuration

### 7. Supplement

### (1. Overall Configuration)

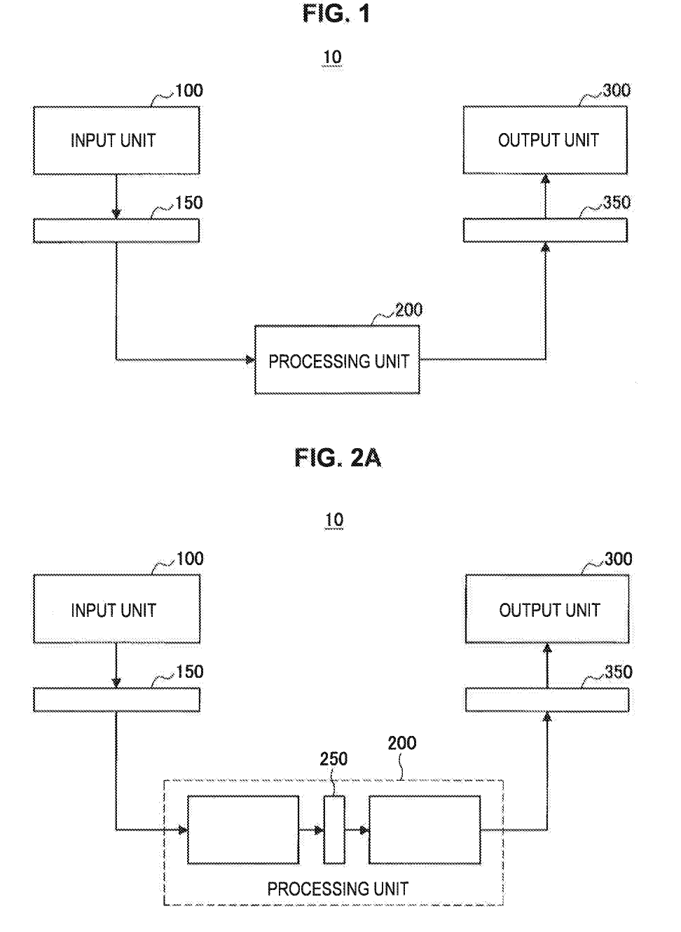

FIG. 1 is a block diagram illustrating an exemplary overall configuration of an embodiment of the present disclosure. Referring to FIG. 1, a system 10 includes an input unit 100, a processing unit 200, and an output unit 300. The input unit 100, the processing unit 200, and the output unit 300 are realized by one or a plurality of information processing apparatuses as illustrated in the exemplary configuration of the system 10 described later.

### (1-1. Input Unit)

For example, the input unit 100 includes a manipulation input device, a sensor, software that acquires information from an external service, or the like and receives inputs of a variety of information from a user, an ambient environment, or other services.

For example, the manipulation input device includes a hardware button, a keyboard, a mouse, a touch panel, a touch sensor, a proximity sensor, an acceleration sensor, a gyro sensor, a temperature sensor, or the like and receives a manipulation input made by the user. The manipulation input device may also include a camera (i.e., an image sensor), a microphone, or the like that receives a manipulation input that is expressed by a gesture or voice of the user.

In addition, the input unit 100 may include a processor or a processing circuit that converts a signal or data acquired by the manipulation input device into a manipulation command. Alternatively, the input unit 100 may output the signal or data acquired by the manipulation input device to an interface 150 without conversion into a manipulation command. In this case, the signal or data acquired by the manipulation input device is converted into a manipulation command, for example, by the processing unit 200.

The sensors include an acceleration sensor, a gyro sensor, a geomagnetic sensor, an illuminance sensor, a temperature sensor, a barometric sensor, or the like and detects acceleration, an angular velocity, a geographic direction, an illuminance, a temperature, or an atmospheric pressure applied to or associated with the device. These various sensors may detect a variety of information as information regarding the user (for example, as information representing the user's movement or orientation) when the user carries or wears a device including the sensors. The sensors may also include sensors that detect biological information of the user such as a pulse, a sweat, a brain wave, a tactile sense, a smell sense, a taste sense, or the like. The input unit 100 may include a processing circuit that acquires information representing the user's emotion by analyzing data of an image or sound detected by a camera or a microphone described later and/or information detected by such sensors. Alternatively, the information and/or data may be output to the interface 150 without undergoing the analysis and may then be analyzed, for example, by the processing unit 200.

The sensors may acquire, as data, an image or sound around the user or device by a camera, a microphone, the various sensors described above, or the like. The sensors may also include a position detection means that detects an indoor or outdoor position. Specifically, the position detection means may include a global navigation satellite system (GNSS) receiver, a communication device and/or the like. For example, the GNSS may include a global positioning system (GPS), a global navigation satellite system (GLONASS), a Beidou navigation satellite system (BDS), a Quasi-Zenith satellites system (QZSS), Galileo, or the like. Although the following description will be given with reference to the case where the GPS is used as an example, a different GNSS may also be used in the same manner. The communication device performs position detection using a technology such as, for example, Wi-Fi, multi-input multi-output (MIMO), cellular communication (for example, position detection using a mobile base station or a femto cell), or local wireless communication (for example, Bluetooth low energy (BLE) or Bluetooth (registered trademark)).

In the case where the sensors described above detect the user's position or situation (including biological information), the device including the sensors is, for example, carried or worn by the user. Alternatively, when the device including the sensors is installed in a living environment of the user, it may also be possible to detect the user's position or situation (including biological information). For example, it is possible to detect the user's pulse by analyzing an image including the user's face acquired by a camera fixedly installed in an indoor space or the like.

The input unit 100 may also include a processor or a processing circuit that converts a signal or data acquired by a sensor into a predetermined format (for example, a processor or a processing circuit that converts an analog signal into a digital signal or that encodes data of an image or sound). Alternatively, the input unit 100 may output the acquired signal or data to the interface 150 without conversion into a predetermined format. In this case, the signal or data acquired by the sensor is converted into a manipulation command by the processing unit 200.

The software that acquires information from the external service acquires, for example, a variety of information provided by the external service using an application program interface (API) of the external service. For example, the software may acquire information from a server of the external service and may also acquire information from application software of a service that is being executed on a client device. For example, information such as text or an image that the user or another user has posted to an external service of social media or the like may be acquired by the software, The acquired information may not necessarily be posted intentionally by the user or another user. For example, the acquired information may be a log of manipulations performed by the user or another user. The acquired information is not limited to personal information of the user or another user and may include, for example, information which is broadcast to public users such as news, weather forecast, traffic information, point of interest (POI), or advertisement.

In addition, the information acquired from the external service may include information that is generated by posting, to the external service, the information acquired by the various sensors described above such as, for example, acceleration, an angular velocity, a geographic direction, an illuminance, a temperature, an atmospheric pressure, a pulse, a sweat, a brain wave, a tactile sense, a smell sense, a taste sense, other biological information, emotion, or position information after being detected by sensors included in another system that cooperates with the external service.

The interface 150 is an interface between the input unit 100 and the processing unit 200. For example, in the case where the input unit 100 and the processing unit 200 are realized by separate devices, the interface 150 may include a wired or wireless communication interface. The Internet may also be present between the input unit 100 and the processing unit 200. More specifically, the wired or wireless communication interface may include a cellular communication interface such as 3G/LTE, Wi-Fi, Bluetooth (registered trademark), near field communication (NFC), Ethernet (registered trademark), a high-definition multimedia interface (HDMI) (registered trademark), or a universal serial bus (USB). In addition, in the case where at least a part of the processing unit 200 and the input unit 100 are realized by the same device, the interface 150 may include a bus in the device, a data reference in a program module, or the like (which are hereinafter also referred to as “intra-device interfaces”). Further, in the case where the input unit 100 is realized in a distributed manner over a plurality of devices, the interface 150 may include different types of interfaces respectively for the devices. For example, the interface 150 may include both a communication interface arid an intra-device interface.

### (1-2. Processing Unit)

The processing unit 200 performs various processes on the basis of information acquired by the input unit 100. More specifically, the processing unit 200 includes, for example, a processor or a processing circuit such as a central processing unit (CPU), a digital signal processor (DSP), an application specific integrated circuit (ASIC), or a field-programmable gate array (FPGA). The processing unit 200 may include a memory or a storage device that temporally or permanently stores data read or written during execution of a program and a process by the processor or the processing circuit.

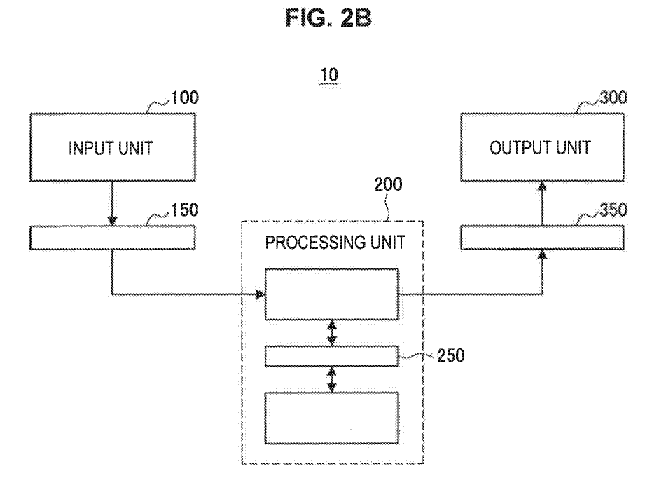

The processing unit 200 may be realized by a single processor or processing circuit in a single device or may be realized in a distributed manner over a plurality of devices or a plurality of processors or processing circuits in the same device. In the case where the processing unit 200 is realized in a distributed manner, an interface 250 is provided between divided parts of the processing unit 200 as in an example shown in FIGS. 2A and 2B. Similar to the interface 150 described above, the interface 250 may include a communication interface or an intra-device interface.

Although the processing unit 200 is exemplified by individual functional blocks that constitute the processing unit 200 in the later detailed description of the processing unit 200, the interface 250 may be provided between any functional blocks. That is, in the case where the processing unit 200 is realized in a distributed manner over a plurality devices or a plurality of processors or processing circuits, how the functional blocks are distributed to each device, each processor, or each processing circuit is arbitrary unless stated otherwise.

### (1-3. Output Unit)

The output unit 300 outputs information provided from the processing unit 200 to a user (who may be the same as or different from the user of the input unit 100), an external device, or other services. For example, the output unit 300 includes software that provides information to an output device, a control device or an external service.

The output device outputs the information provided from the processing unit 200 in a format that is perceived by a sense such as a visual sense, a hearing sense, a tactile sense, a smell sense, or a taste sense of the user (who may be the same as or different from the user of the input unit 100). For example, the output device is a display that outputs information through an image. The display is not limited to a reflective or self-luminous display such as an electro-luminescence (EL) display or a crystal display (LCD) and includes a combination of a light source and a waveguide that guides light for image display to the user's eyes, similar to those used in wearable devices. The output device may include a speaker to output information through a sound. The output device may also include a projector, a vibrator, or the like.

The control device controls a device on the basis of information provided from the processing unit 200. The device controlled may be included in a device that realizes the output unit 300 or may be an external device. More specifically, the control device includes, for example, a processor or a processing circuit that generates a control command. In the case where the control device controls an external device, the output unit 300 may further include a communication device that transmits a control command to the external device. For example, the control device controls a printer that outputs information provided from the processing unit 200 as a printed material. The control device may include a driver that controls writing of information provided from the processing unit 200 to a storage device or a removable recording medium. Alternatively, the control device may control devices other than the device that outputs or records information provided from the processing unit 200. For example, the control device may control a lighting device to activate lights, control a television to turn the display off, control an audio device to adjust the volume, or control a robot to control its movement or the like.

The software that provides information to an external service provides, for example, information provided from the processing unit 200 to the external service using an API of the external service. The software may provide information to a server of an external service or may provide information to application software of a service that is being executed on a client device. The provided information may not necessarily be reflected immediately in the external service. For example, the information may be provided as a candidate for posting or transmission by the user to the external service. More specifically, the software may provide, for example, text that is used as a candidate for a uniform resource locator (URL) or a search keyword that the user inputs on browser software that is being executed on a client device. For example, the software may post text, an image, a moving image, audio or the like to an external service of social media or the like on the user's behalf.

The interface 350 is an interface between the processing unit 200 and the output unit 300. For example, in the case where the processing unit 200 and the output unit 300 are realized by separate devices, the interface 350 may include a wired or wireless communication interface, In addition, in the case where at least a part of the processing unit 200 and the output unit 300 are realized by the same device, the interface 350 may include an intra-device interface that is described above. Further, in the case where the output unit 300 is realized in a distributed manner over a plurality of devices, the interface 350 may include different types of interfaces respectively for the devices. For example, the interface 350 may include both a communication interface and an intra-device interface.

### (2. Exemplary Functional Configuration)

### (2-1. When Position Estimation is Performed)

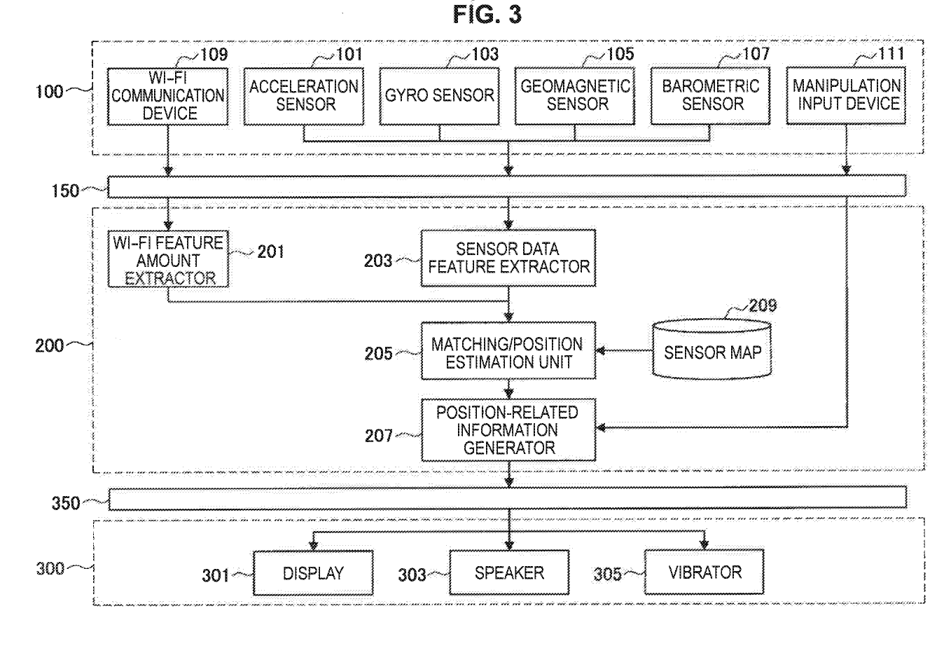

FIG. 3 is a schematic block diagram illustrating an exemplary functional configuration of an input unit, a processing unit, and an output unit when position estimation is performed according to an embodiment of the present disclosure. An exemplary functional configuration of the input unit 100, the processing unit 200, and the output unit 300 included in the system 10 according to the present embodiment when position estimation is performed will now be described with reference to FIG. 3.

The input unit 100 includes, as sensors, an acceleration sensor 101, a gyro sensor 103, a geomagnetic sensor 105, a barometric sensor 107, and/or a Wi-Fi communication device 109. Although the Wi-Fi communication device 109 is intrinsically a communication device, it is used as a sensor for detecting a reception state of radio waves in the present embodiment. Of course, the Wi-Fi communication device 109 may be used as the intrinsic communication functionality while being used as a sensor for detecting the reception state of radio waves. For example, the sensors are carried or worn by the user. More specifically, the user carries or wears, for example, a terminal device to which the sensors are mounted.

Measured values of the acceleration, the angular velocity, the geomagnetism, and/or the atmospheric pressure provided by the sensors are provided as sensor data to the processing unit 200. In the present embodiment, the sensor data is used to perform matching with position information as described later and therefore it is not necessarily limited to sensor data which can directly indicate the user's behavior or position. Thus, the input unit 100 may further include other types of sensors as the sensors. Some of the sensors exemplified above may not be included in the input unit 100.

On the other hand, the Wi-Fi communication device 109, which is used as a position sensor, communicates with one or a plurality of Wi-Fi base stations (access points) installed in a space in which the user is movable. The respective installation positions of the access points may not necessarily be specified. The Wi-Fi communication device 109 provides information indicating an access point that has been communicable with the Wi-Fi communication device 109 and information including the strength of radio waves from the access point that has been communicable, as sensor data, to the processing unit 200.

The manipulation input device 111 acquires, for example, a manipulation input indicating the user's instruction regarding generation of position-related information described later. As described above, the input unit 100 may further include a processor or a processing circuit for converting or analyzing data acquired by the sensors and the manipulation input device.

The processing unit 200 may include a Wi-Fi feature amount extractor 201, a sensor data feature extractor 203, a matching/position estimation unit 205, a position-related information generator 207, and a sensor map 209. These functional elements are realized, for example, by a processor or a processing circuit and a memory or storage of a server that communicates with the terminal device. A part of the functional elements may be realized by a processor or a processing circuit in the same terminal device as the sensors or the manipulation input device included in the input unit 100. A specific example of this configuration will be described later. Each of the functional elements is further described below.

The Wi-Fi feature amount extractor 201 extracts a feature amount relating to Wi-Fi communication from sensor data provided by the Wi-Fi communication device 109 of the input unit 100 For example, the Wi-Fi feature amount extractor 201 extracts a Wi-Fi feature amount by hashing a communicable access point and the strength of radio waves from the access point. More specifically, the Wi-Fi feature amount extractor 201 may extract a Wi-Fi feature amount by summing random vectors allocated uniquely to access points arranged in the space in which the user moves after weighting the random vectors in accordance with the respective strengths of radio waves from the access points.

In the present embodiment, a Wi-Fi feature amount is not intended to directly indicate position information but patterns both an access point that has been communicable and the strength of radio waves from the access point. Therefore, for example, in the case where Wi-Fi feature amounts (vectors) extracted from sensor data at individual times are adjacent to each other, there is a possibility that positions of the user at those times are close to each other, but at this time it is not necessary to know the corresponding positions. Accordingly, the IDs of individual access points or Wi-Fi feature amounts that do not include position information of access points are extracted in the present embodiment. For example, even when an access point is added/removed or moved, there is no need to change the setting values or the procedure of Wi-Fi feature amount extraction and map generation may be performed as described later using the changed arrangement of access points.

The sensor data feature extractor 203 extracts various features from sensor data provided by the acceleration sensor 101, the gyro sensor 103, the geomagnetic sensor 105, and/or the barometric sensor 107 of the input unit 100. The extracted features may include a feature that is expressed as a feature amount and may include a feature that is not necessarily quantified, like a behavior label described later. More specifically, the sensor data feature extractor 203 may extract, for example, a gravity component, an acceleration component other than gravity, and/or a movement speed of the user from a detected value of the acceleration provided by the acceleration sensor 101. For example, the sensor data feature extractor 203 may extract an angular velocity about the vertical axis from a detected value of the angular velocity provided by the gyro sensor 103. For example, the sensor data feature extractor 203 may further extract a geographic direction from a detected value of the geomagnetism provided by the geomagnetic sensor 105.

Further, the sensor data feature extractor 203 may perform behavior recognition based on sensor data and extract, as a feature of the sensor data, a behavior label of the user specified by the behavior recognition. That is, the sensor data feature extractor 203 may include a behavior recognition unit. Through behavior recognition, it is possible to recognize, for example, behavior labels such as a stay, a walk, a run, a jump, stairs, an elevator, an escalator, a bicycle, a bus, a railway train, an automobile, a ship, or an airplane. A detailed description of the behavior recognition technologies is omitted herein since they are described in a lot of literatures including, for example, JP 2012-8771A. In the present embodiment, the behavior recognition unit may employ any configuration of known behavior recognition technologies.

The matching/position estimation unit 205 performs matching between a feature of sensor data extracted by the Wi-Fi feature amount extractor 201 and the sensor data feature extractor 203 (hereinafter, sometimes collectively referred to as a “feature extractor”) and a feature of sensor data that is associated with given position information in the sensor map 209. Here, the feature of the sensor data extracted by the feature extractor and the feature of the sensor data that is associated with the position information in the sensor map 209 correspond to each other. More specifically, the features of both the sensor data may include a common type of features among the features of the sensor data described above.

Further, the matching/position estimation unit 205 estimates the user's position on the basis of the result of the matching. That is, when a feature of first sensor data extracted by the feature extractor and a feature of second sensor data defined in the sensor map 209 have matched each other, the matching/position estimation unit 205 estimates the user's position as a position corresponding to position information that is associated with the second sensor data.

The matching/position estimation unit 205 may perform such position estimation on the basis of a snapshot of sensor data that is provided by a sensor at a single time. The matching/position estimation unit 205 may also perform position estimation on the basis of time-series sensor data, i.e., sensor data that is provided by a sensor over a series of consecutive times. In this case, the matching/position estimation unit 205 performs matching between features of first sensor data, which are extracted by the feature extractor and constitute a time series, and features of second sensor data which are associated respectively with a series of position information items that are, for example, adjacent to each other to constitute a path. For example, even when similar features of sensor data have been acquired at a plurality of different positions, it is possible to perform more correct position estimation by performing matching of time-series sensor data.

A position-related information generator 207 generates information, which is to be output to the user by the output unit 300, on the basis of information provided from the matching/position estimation unit 205. More specifically, the position-related information generator 207 may generate, for example, information acquired by arranging information, which is based on a behavior label specified by the behavior recognition unit included in the sensor data feature extractor 203, on a map generated based on the user's position estimated by the matching/position estimation unit 205. Alternatively, the position-related information generator 207 may simply generate information indicating the user's whereabouts on a map. In these cases, the map used to generate the information may be a map made up of correct position information defined in the sensor map 209. The information generated by the position-related information generator 207 may be output to the output unit 300 via the interface 350.

The output unit 300 may include a display 301, a speaker 303, and a vibrator 305. The display 301, the speaker 303, and the vibrator 305 are mounted, for example, to a terminal device that is carried or worn by the user. The display 301 outputs information as an image, the speaker outputs information as a sound, and the vibrator outputs information as a vibration. The output information may include information generated by the position-related information generator 207. The display 301, the speaker 303, or the vibrator 305 may be mounted to the same terminal device as that of the sensors of the input unit 100. The display 301, the speaker 303, or the vibrator 305 may also be mounted to the same terminal device as that of the manipulation input device 111 of the input unit 100. Alternatively, the display 301, the speaker 303, or the vibrator 305 may be mounted to a terminal device different from that of the elements of the input unit 100. More specific examples of the configurations of the terminal device and the server that realize the input unit 100, the processing unit 200 and the output unit 300 will be described later.

### (2-2. When Map Learning is Performed)

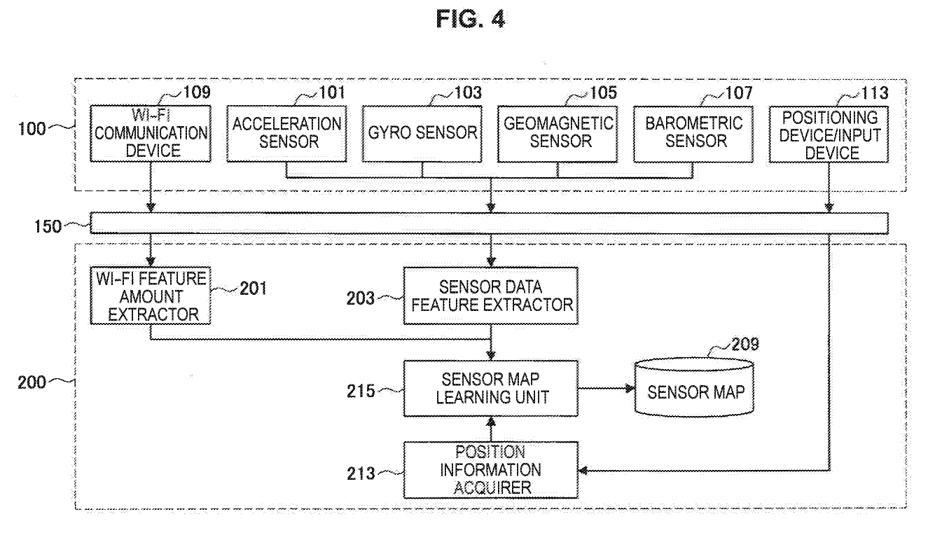

FIG. 4 is a schematic block diagram illustrating an exemplary functional configuration of an input unit, a processing unit, and an output unit when map learning is performed according to an embodiment of the present disclosure. An exemplary functional configuration of the input unit 100 and the processing unit 200 included in the system 10 according to the present embodiment when map learning is performed will now be described with reference to FIG. 4. Although the output unit 300 may output, for example, information indicating the progress of map learning, a generated map or the like to the user who is performing map learning, the illustration and description of the output unit 300 is omitted in the example when map learning is performed since the present embodiment does not target the output unit 300 itself.

The input unit 100 includes, as sensors, an acceleration sensor 101, a gyro sensor 103, a geomagnetic sensor 105, a barometric sensor 107, and/or a Wi-Fi communication device 109. In the example when map learning is performed, the sensors included in the input unit 100 may be the same as those when position estimation is performed. The input unit 100 further includes a positioning device/input device 113. A description will now be given of the positioning device/input device 113, which is an element of the input unit 100 different from the above example when position estimation is performed.

The positioning device/input device 113 is used to acquire position information in parallel with the acquisition of sensor data. In the procedure of map leaning, the position information acquired by the positioning device/input device 113 is handled as correct position information. For example, the correct position information may be acquired by visual simultaneous localization and mapping (SLAM) using an image acquired by a camera carried or worn by the user in the course of their moving around within the space in which the user is movable. In this case, the positioning device/input device 113 includes a camera or the like to acquire images. Calculation for visual SLAM may be performed by the input unit 100 and may also be performed by the processing unit 200. SLAM is a technique for performing self-position estimation and structure mapping of environments in parallel and is described, for example, in JP2007-156016A, etc. “Visual SLAM” refers to SLAM that is performed, especially, using images. In visual SLAM, images may be acquired, for example, through a stereo camera (two or more camera units) and may also be acquired by moving a single camera.

Alternatively, the correct position information may be absolute coordinates within the space input by the user (or by their assistant). In this case, the positioning device/input device 113 is realized, for example, by an input device that receives an input of absolute coordinates. For example, the absolute coordinates may be input in real time when the user moves around within the space and may also be input with reference to the user's images or the like at a later time.

The processing unit 200 may include a Wi-Fi feature amount extractor 201, a sensor data feature extractor 203, a position information acquirer 213, and a sensor map learning unit 215. The process of extracting, by the Wi-Fi feature amount extractor 201 and the sensor data feature extractor 203 (i.e., by the feature extractor), features of sensor data provided by the sensors of the input unit 100 is similar to the above example when position estimation is performed. However, when map learning is performed, the extracted feature amount of the sensor data is input to the sensor map learning unit 215. The sensor map learning unit 215 generates a sensor map 209 by associating the extracted feature amount of the sensor data with the correct position information acquired by the position information acquirer 213.

More specifically, for example, the sensor map learning unit 215 associates, for example, a feature of sensor data extracted by the feature extractor with correct position information acquired by the position information acquirer 213, for example, in accordance with a probability model. This makes it possible to express, in the sensor map 209, an observation probability of a feature of sensor data in a state defined by correct position information. In this case, for example, it is possible to estimate the user's position as a position corresponding to a state having an observation probability which most closely matches a feature extracted from sensor data acquired at a single time when position estimation is performed.

In addition, for example, the sensor map learning unit 215 may calculate a transition probability between states defined by correct position information. This makes it possible to express, in the sensor map 209, an observation probability of a feature of sensor data in a state defined by correct position information and a transition probability between states. In this case, for example, it is possible to perform position estimation on the basis of observation probabilities and transition probabilities extracted from sensor data that constitutes a time series. For example, it is possible to estimate, as a recent movement history of the user, a series of positions corresponding to individual states, of which observation probabilities and transition probabilities (i.e., transition probabilities between a series of the states) more closely match a series of features extracted from sensor data that constitutes a time series when position estimation is performed.

### (3. Principle of Map Learning and Position Estimation)

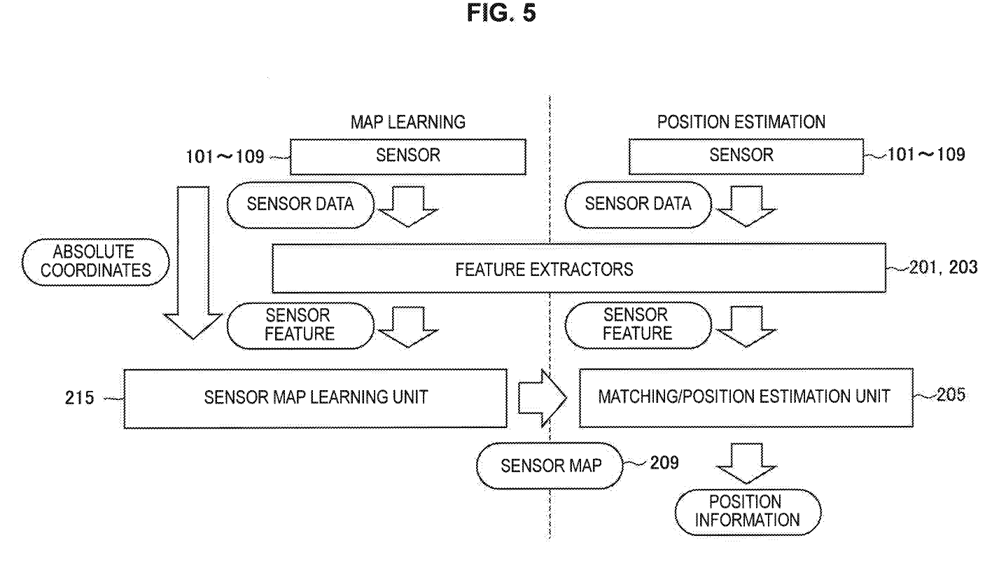

FIG. 5 is a diagram for explaining an overview of map learning and position estimation according to an embodiment of the present disclosure. FIG. 5 conceptually shows the relationship between information and processes in map learning and position estimation performed in the system 10 which have been described above with reference to FIGS. 3 and 4.

When map learning is performed as advance preparation, the feature extractors 201 and 203 extract features from sensor data provided by the sensors (for example, the acceleration sensor 101, the gyro sensor 103, the geomagnetic sensor 105, the barometric sensor 107, and/or the Wi-Fi communication device 109). This feature extraction is performed to remove redundant parts or noise components included in the sensor data and to facilitate matching when positioning is performed. In the present embodiment, changes of sensor data due to the user's behavior (for example, small body shaking) in a smaller level than their movements such as walking may also be regarded as noise since the present embodiment aims at position estimation of the user by matching of features.

In addition, when map learning is performed, the sensor map learning unit 215 associates features of sensor data that have been extracted by the feature extractors 201 and 203 as described above with correct position information (for example, absolute coordinates) that has been separately acquired and generates a sensor map 209 through learning. For example, a probability model such as an incremental hidden Markov model (IHMM) may be used for learning. That is, in the sensor map, features of sensor data may be associated with position information in accordance with a probability model. IHMM will be further described later.

On the other hand, when position estimation is performed, the feature extractors 201 and 203 extract features from sensor data provided by the sensors, similar to when map learning is performed. The extracted features are input to the matching/position estimation unit 205 and position information is estimated through matching with features defined in the sensor map 209.

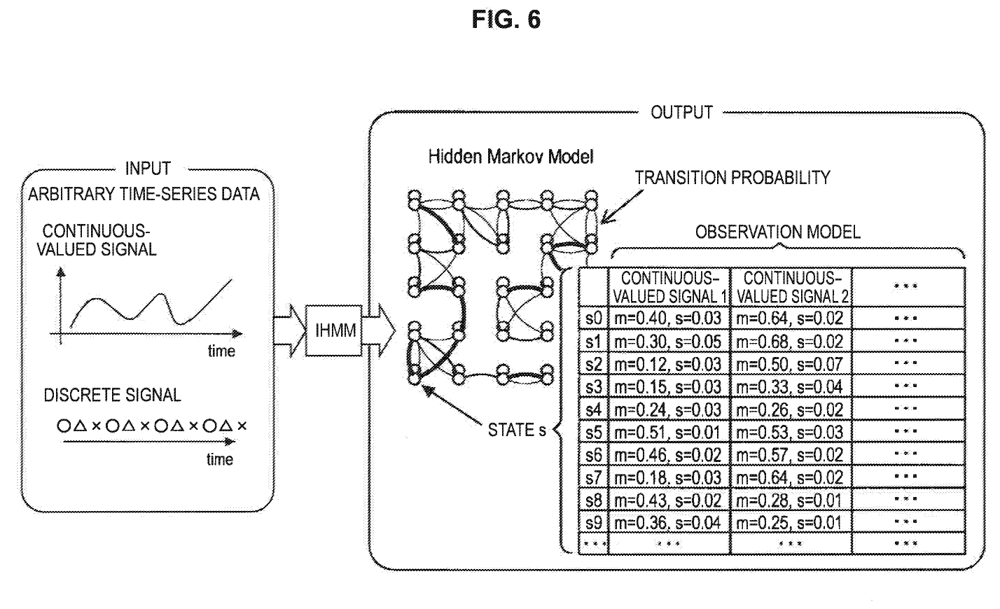

FIG. 6 is a diagram for explaining an exemplary probability model used in an embodiment of the present disclosure. In FIG. 6, IHMM is described as an example of the model used to generate the sensor map 209 in the present embodiment.

In FIG. 6, arbitrary time-series data is shown as an input of the model. The arbitrary time-series data may be a continuous-valued signal and may also be a discrete signal. The continuous-valued signal includes a pseudo-continuous-valued signal that is provided as a digital signal. For example, in the example of the present embodiment, a gravity component, an acceleration component other than gravity; and/or a movement speed of the user extracted from a detected value of the acceleration, an angular velocity about the vertical axis extracted from a detected value of the angular velocity, or a geographic direction extracted from a detected value of the geomagnetism may each constitute a continuous-valued signal. A Wi-Fi feature amount may constitute a discrete signal.

IHMM is a technique for learning a rule behind, as a state transition model (HMM), from time-series data that has been input serially (incrementally). IHMM is described, for example, in JP2012-8659A and JP2012-108748A. A state transition model shown as an output in FIG. 6 is expressed by a plurality of states, respective observation models of the states, and transition probabilities between the states.

In the present embodiment, a state including a feature extracted from sensor data and correct position information (absolute coordinates) acquired in parallel with the sensor data is defined in the sensor map 209. Here, only position information among the time-series data may be used when a state is defined in IHMM or when a transition probability between states is calculated. This is because position information is the most accurate in the procedure when map learning of the present embodiment is performed and thus it is appropriate that states be defined as the same when position information is common even though features extracted from sensor data differ. This process may be realized, for example, by setting “1” to a weight for the learning of position information (absolute coordinates) and “0” to weights for other observation states in a library of IHMM.

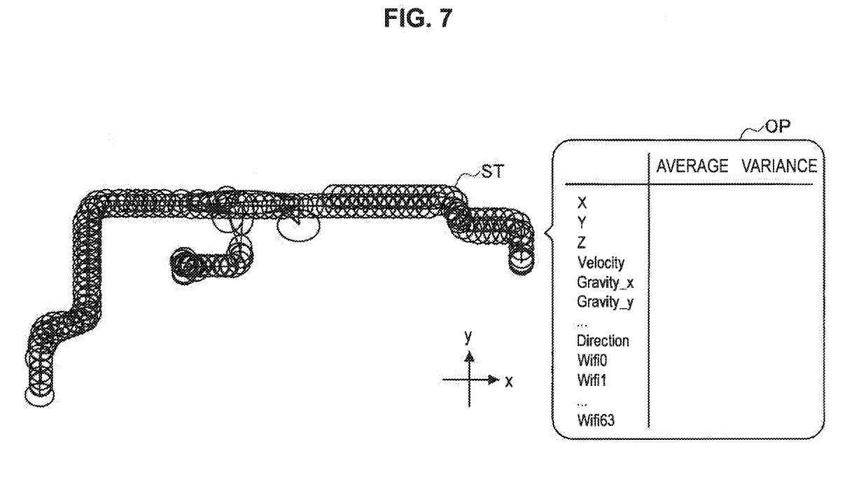

FIG. 7 is a view illustrating an exemplary sensor map generated in an embodiment of the present disclosure. In FIG. 7, a state ST defined in the sensor map 209 is shown as a circle or an ellipse. A state's observation probability OP is defined for each state ST. In the shown example, the observation probability OP of each state is expressed by an average and a variance of each feature of sensor data of the state. The center of a circle or an ellipse shown as the state ST represents an average of the X and Y coordinates in the observation probability OP. In addition, the diameter of the circle or (the major and minor diameters of) the ellipse represents a variance of the X and Y coordinates in the observation probability OP. Each line that connects circles or ellipses shown as states ST represents that the transition probability between the states ST is greater than 0.

### (4. Implementation)

An implementation of the present disclosure will now be described. The present implementation is only a more specific example provided for understanding the embodiment of the present disclosure and is not intended to restrict the embodiment of the present disclosure to the scope of the present implementation.

In the present implementation, a 3-axis acceleration sensor, a 3-axis gyro sensor, and a 3-axis geomagnetic sensor are used as the acceleration sensor 101, the gyro sensor 103, and the geomagnetic sensor 105 included in the input unit 100 of the system 10 according to the embodiment of the present disclosure described above, The sampling frequencies are all 50 Hz. The Wi-Fi communication device 109 outputs the ID of an access point that has been communicable and the strength of radio waves from the access point.

In the processing unit 200, the Wi-Fi feature amount extractor 201 allocates respective 64-dimensional Gauss random vectors to the access points and weights the random vectors in accordance with the strengths of radio waves from the access points and then sums the weighted random vectors to extract a Wi-Fi feature amount as a 64-dimensional real-valued vector. On the other hand, the sensor data feature extractor 203 performs behavior recognition on the basis of detected values of the acceleration, the angular velocity, and the geomagnetism and specifies 8 behavior labels of a rest, a walk, a left turn, a right turn, a stair ascent, a stair descent, an escalator ascent, and an escalator descent.

The sensor data feature extractor 203 further extracts feature amounts described below from detected values of the acceleration, the angular velocity, and the geomagnetism. The gravity is acquired by inputting respective detected values of the accelerations of the three axes (X, Y, and Z axes) to a low pass filter and extracting signals of the forward, lateral and vertical directions. The accelerations of the axes (other than gravity) are acquired by subtracting the acquired gravity value from the detected values of the accelerations of the axes and then extracting signals of the forward, lateral and vertical directions. The geomagnetism is acquired by extracting signals of the forward, lateral and vertical directions from the detected values of the geomagnetism. The angular velocity is extracted by estimating and removing an offset at the time when the user is at rest as estimated from the accelerations.
Speed (m/s)
Gravity (forward, lateral, vertical) (m/s²)
Acceleration (other than gravity; forward, lateral, vertical) (m/s²)
Angular velocity (forward, lateral, vertical) (μT)
Geographic direction (0 for north, positive for clockwise) (deg)

The Wi-Fi feature amount extractor 201 and the sensor data feature extractor 203 extracts the features of the sensor data described above every second of the time stamp of the sensor data.

Position estimation of the present implementation described above improves the accuracy of position estimation using a plurality of sensor data (for example, compared to the case where only the Wi-Fi feature amounts are used). In addition, in the case where a plurality of sensor data is used, the accuracy of position estimation is improved by performing matching with features of a plurality of sensor data that constitutes a time series, compared to the case where matching is performed with features of sensor data at a single time. in the case where features of a plurality of sensor data that constitutes a time series are used, the longer the time series, the higher the accuracy of the position estimation.

According to the embodiment of the present disclosure, it is possible to estimate the user's position with high accuracy by matching features of sensor data provided by one or a plurality of sensors carried or worn by the user with features of sensor data that have been associated with given position information. For example, position estimation according to the present embodiment is hardly affected by accumulation of errors, compared to autonomous positioning that is performed using acceleration, angular velocity, geomagnetism, or the like.

In addition, in the present embodiment, the restriction on the content of the sensor data is small since features of the sensor data are used for matching. For example, while sensor data items such as acceleration, angular velocity, and geomagnetism are often essential in the case of autonomous positioning, some of these sensor data items may not be needed temporarily or from the beginning (and none may be needed when other available sensor data is sufficient) in the present embodiment. In addition, for the information regarding Wi-Fi communication, it is only necessary to identify access points since the information is not intended to estimate the user's position on the basis of the positions of the access points as described above.

Accordingly, as the sensor data according to the present embodiment, it is possible to use a variety of data in addition to or instead of those exemplified above. For example, as sensor data representing a reception state of radio waves, similar to the Wi-Fi reception state, it is possible to use a reception state of radio waves from a beacon installed in the space in which the user is movable or to use low-accuracy GNSS positioning data or the like due to indoors, buildings or the like (and position estimation itself is unnecessary when high-accuracy GNSS positioning data is available). These data items can also be used as sensor data since it is considered that the data items change in a certain relationship with the user's position, similar to the Wi-Fi feature amount.

In the above example, a behavior label of a user specified by behavior recognition that is based on sensor data is used as a feature of the sensor data, but this is not necessary. For example, in the case where a behavior label of a user is not used as a feature of sensor data, the user does not necessarily have to move around within the space to collect sensor data when map learning is performed. In this case, for example, a robot with a terminal device mounted thereto may be allowed to move around to collect sensor data for map learning.

The results of position estimation according to the present embodiment may not only be used to generate, by the position-related information generator 207 described above, information to be output to the user but may also be used, for example, to predict the user's destination for activating lights in a room or a passage in advance, to appropriately perform switching between access points of Wi-Fi or the like, or to provide another user in the destination with advance notice of the arrival. Without being limited to the user's movement estimation, the position estimation results may also be used, for example, as a history of position information of the terminal device with the sensors mounted thereto. For example, in the case where the user has lost a smartphone, it is possible to estimate the whereabouts of the smartphone when results of recent position estimation acquired when the user has carried the smartphone are available.

### (5. System Configuration)

An embodiment of the present disclosure has been described above. As described above, the system 10 according to the present embodiment includes an input unit 100, a processing unit 200, and an output unit 300. These elements are realized by one or a plurality of information processing apparatuses. Examples of a combination of information processing apparatuses that realize the system 10 are described below together with more specific examples.

### First Example

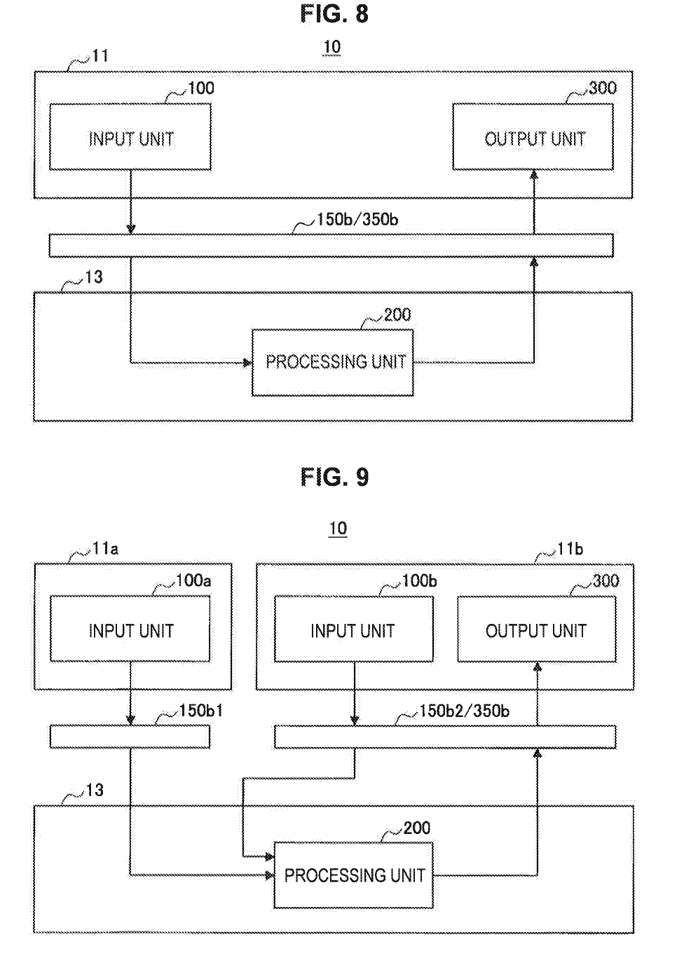

FIG. 8 is a block diagram illustrating a first example of the configuration of the system according to an embodiment of the present disclosure. Referring to FIG. 8, the system 10 includes information processing apparatuses 11 and 13. The input unit 100 and the output unit 300 are realized in the information processing apparatus 11. On the other hand, the processing unit 200 is realized in the information processing apparatus 13. The information processing apparatuses 11 and 13 communicate with each other via a network to realize the functions according to the embodiment of the present disclosure. An interface 150b between the input unit 100 and the processing unit 200 and an interface 350b between the processing unit 200 and the output unit 300 may each be an inter-device communication interface.

In the first example, the information processing apparatus 11 may be, for example, a terminal device. In this case, the input unit 100 may include an input device, a sensor, software that acquires information from an external service, or the like. The software that acquires information from the external service acquires data, for example, from application software of a service that is being executed on the terminal device. The output unit 300 may include an output device, a control device, software that provides information to an external service, or the like. The software that provides information to the external service may provide information, for example, to application software of a service that is being executed on the terminal device.

In the first example, the information processing apparatus 13 may be a server. The processing unit 200 is realized by operation of a processor or a processing circuit included in the information processing apparatus 13 in accordance with a program stored in a memory or a storage device. The information processing apparatus 13 may be, for example, a device dedicated as a server. In this case, the information processing apparatus 13 may be installed in a data center or the like and may also be installed in a household. Alternatively, the information processing apparatus 13 may be a device that does not realize the input unit 100 and the output unit 300 in association with the functions according to the embodiment of the present disclosure but may be used as a terminal device for other functions.

### Second Example

FIG. 9 is a block diagram illustrating a second example of the configuration of the system according to an embodiment of the present disclosure. Referring to FIG. 9, the system 10 includes information processing apparatuses 11a, 11b and 13. The input unit 100 is realized in a divided manner over input units 100a and 100b. The input unit 100a is realized in the information processing apparatus 11a. The input unit 100a includes, for example, the acceleration sensor 101, the gyro sensor 103, the geomagnetic sensor 105, the barometric sensor 107, and/or the Wi-Fi communication device 109 which are described above.

The input unit 100b and the output unit 300 is realized in the information processing apparatus 11b. For example, the input unit 100b may include the manipulation input device 111 described above. The processing unit 200 is realized in the information processing apparatus 13. The information processing apparatuses 11a and 11b and the information processing apparatus 13 communicate with each other via a network to realize the functions according to the embodiment of the present disclosure. Interfaces 150b1 and 150b2 between the input unit 100 and the processing unit 200 and an interface 350b between the processing unit 200 and the output unit 300 may each be an inter-device communication interface. However, in the third example, the interface 150b1 and the interfaces 150b2 and 350b may include different types of interfaces since the information processing apparatus 11a and the information processing apparatus 11b are separate devices.

In the second example, each of the information processing apparatuses 11a and 11b may be, for example, a terminal device. For example, the information processing apparatus 11a is carried or worn by a user to sense the user. On the other hand, the information processing apparatus 11b outputs, to the user, information generated by the information processing apparatus 13 on the basis of a result of the sensing. Here, the information processing apparatus 11b receives the user's manipulation input relating to the output information. Accordingly, the information processing apparatus 11b may not necessarily be carried or worn by the user. Similar to the first example described above, the information processing apparatus 13 may be a server or a terminal device. The processing unit 200 is realized by operation of a processor or a processing circuit included in the information processing apparatus 13 in accordance with a program stored in a memory or a storage device.

### Third Example

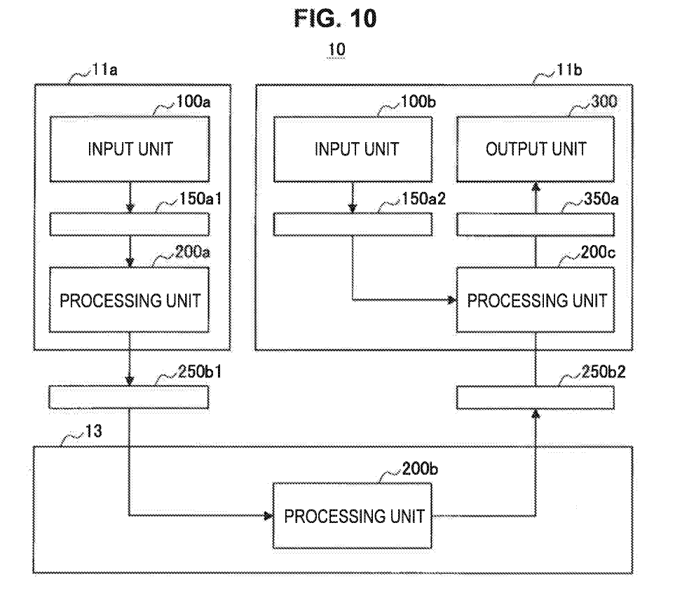

FIG. 10 is a block diagram illustrating a third example of the configuration of the system according to an embodiment of the present disclosure. Referring to FIG. 10, the system 10 includes information processing apparatuses 11 and 13. In the third example, the input unit 100 and the output unit 300 are realized in the information processing apparatus 11. On the other hand, the processing unit 200 is realized in a distributed manner over the information processing apparatus 11 and the information processing apparatus 13. The information processing apparatuses 11 and 13 communicate with each other via a network to realize the functions according to the embodiment of the present disclosure.

In the third example, the processing unit 200 is realized in a distributed manner over the information processing apparatuses 11 and 13 as described above. More specifically, the processing unit 200 includes processing units 200a and 200c realized in the information processing apparatus 11 and a processing unit 200b realized in the information processing apparatus 13. The processing unit 200a performs processing on the basis of information, which is provided from the input unit 100 via an interface 150a, and provides a result of the processing to the processing unit 200b. The processing unit 200a includes, for example, the Wi-Fi feature amount extractor 201 and the sensor data feature extractor 203 which are described above. On the other hand, the processing unit 200c performs processing on the basis of information provided from the processing unit 200b and provides a result of the processing to the output unit 300 via an interface 350a. The processing unit 200c includes, for example, the position-related information generator 207 described above.

Actually, only one of the processing units 200a and 200c may be provided although both the processing units 200a and 200c are illustrated in the shown example. That is, the information processing apparatus 11 may realize the processing unit 200a without realizing the processing unit 200c and information provided from the processing unit 200b may be provided directly to the output unit 300. Similarly, the information processing apparatus 11 may realize the processing unit 200c without realizing the processing unit 200a.

An interface 250b is provided between the processing units 200a and 200b and between the processing units 2006 and 200c. The interface 250b is an inter-device communication interface. On the other hand, the interface 150a is an intra-device interface in the case where the information processing apparatus 11 realizes the processing unit 200a. Similarly, the interface 350a is an intra-device interface in the case where the information processing apparatus 11 realizes the processing unit 200e. In the case where the processing unit 200c includes the position-related information generator 207 as described above, a part of the information from the input unit 100, for example, information from the manipulation input device 111, may be provided to the processing unit 200c directly via the interface 150a.

The third example described above is similar to the first example described above, except that one or both of the processing unit 200a and the processing unit 200c are realized by the processor or the processing circuit included in the information processing apparatus 11. That is, the information processing apparatus 11 may be a terminal device. The information processing apparatus 13 may be a server.

### Fourth Example

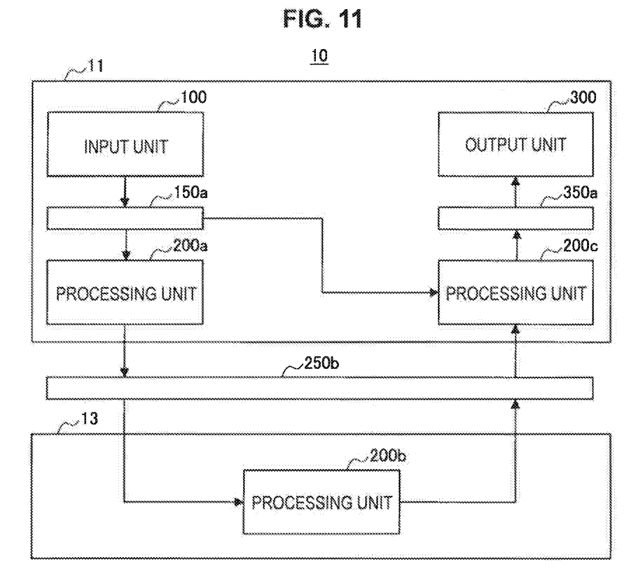

FIG. 11 is a block diagram illustrating a fourth example of the configuration of the system according to an embodiment of the present disclosure. Referring to FIG. 11, the system 10 includes information processing apparatuses 11a, 11b and 13. The input unit 100 is realized in a divided manner over input units 100a and 100b. The input unit 100a is realized in the information processing apparatus 11a. The input unit 100a may include, for example, the acceleration sensor 101, the gyro sensor 103, the geomagnetic sensor 105, the barometric sensor 107, and/or the Wi-Fi communication device 109 which are described above.

The input unit 100b and the output unit 300 are realized in the information processing apparatus 11b. For example, the input unit 100b may include the manipulation input device 111 described above. The processing unit 200 is realized in a distributed manner over the information processing apparatuses 11a and 11b and the information processing apparatus 13. The information processing apparatuses 11a and 11b and the information processing apparatus 13 communicate with each other via a network to realize the functions according to the embodiment of the present disclosure.

In the fourth example, the processing unit 200 is realized in a distributed manner over the information processing apparatuses 11a and 11b and the information processing apparatus 13 as illustrated, More specifically, the processing unit 200 includes a processing unit 200a realized in the information processing apparatus 11a, a processing unit 200b realized in the information processing apparatus 13, and a processing unit 200c realized in the information processing apparatus 11b, Distribution of the processing unit 200 is similar to the third example. However, in the fourth example, interfaces 250b1 and 250b2 may include different types of interfaces since the information processing apparatuses 11a and 11b are separate devices. In the case where the processing unit 200c includes the position-related information generator 207 as described above, information from the input unit 100b, for example, information from the manipulation input device 111, may be provided to the processing unit 200c directly via the interface 150a2.

The fourth example described above is similar to the second example described above, except that one or both of the processing unit 200a and the processing unit 200c are realized by the processor or the processing circuit included in the information processing apparatus 11a or 11b. That is, the information processing apparatus 11a or 11b may be a terminal device. The information processing apparatus 13 may be a server.

### (6. Hardware Configuration)

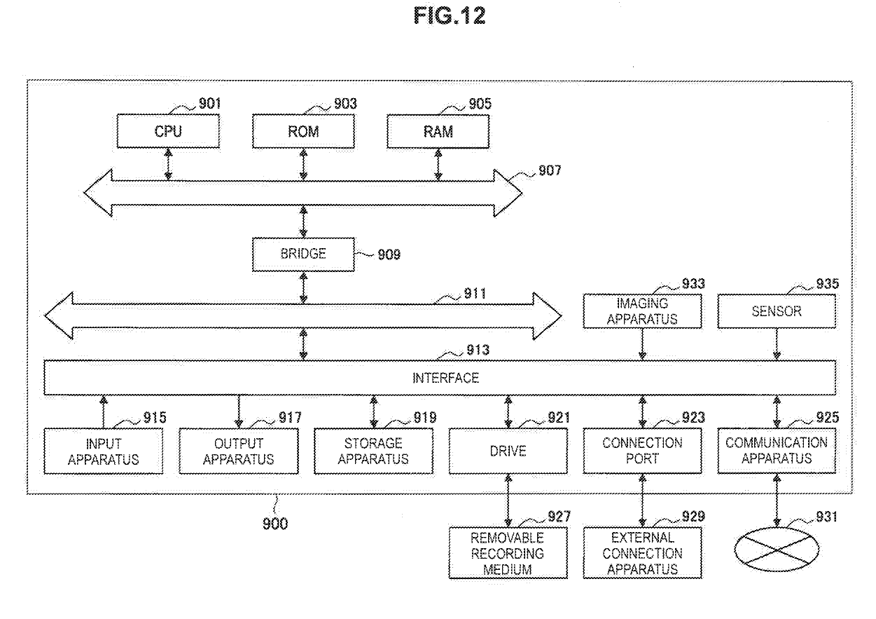

Next, with reference to FIG. 12, a hardware configuration of an information processing apparatus according to an embodiment of the present disclosure is explained. FIG. 12 is a block diagram illustrating a hardware configuration example of an information processing apparatus according to the embodiment of the present disclosure.

The information processing apparatus 900 includes a central processing unit (CPU) 901, read only memory (ROM) 903, and random access memory (RAM) 905, In addition, the information processing apparatus 900 may include a host bus 907, a bridge 909, an external bus 911, an interface 913, an input apparatus 915, an output apparatus 917, a storage apparatus 919, a drive 921, a connection port 923, and a communication apparatus 925. Moreover, the information processing apparatus 900 may include an imaging apparatus 933, and a sensor 935, as necessary. The information processing apparatus 900 may include a processing circuit such as a digital signal processor (DSP), an application-specific integrated circuit (ASIC), or a field-programmable gate array (FPGA), alternatively or in addition to the CPU 901.

The CPU 901 serves as an arithmetic processing apparatus and a control apparatus, and controls the overall operation or a part of the operation of the information processing apparatus 900 according to various programs recorded in the ROM 903, the RAM 905, the storage apparatus 919, or a removable recording medium 927. The ROM 903 stores programs, operation parameters, and the like used by the CPU 901. The RAM 905 transiently stores programs used when the CPU 901 is executed, and various parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input apparatus 915 is a device operated by a user such as a mouse, a keyboard, a touch panel, a button, a switch, and a lever. The input apparatus 915 may be a remote control device that uses, for example, infrared radiation and another type of radiowave. Alternatively, the input apparatus 915 may be an external connection apparatus 929 such as a mobile phone that corresponds to an operation of the information processing apparatus 900. The input apparatus 915 includes an input control circuit that generates input signals on the basis of information which is input by a user to output the generated input signals to the CPU 901. A user inputs various types of data to the information processing apparatus 900 and instructs the information processing apparatus 900 to perform a processing operation by operating the input apparatus 915.

The output apparatus 917 includes an apparatus that can report acquired information to a user visually, audibly, or haptically. The output apparatus 917 may be, for example, a display device such as a liquid crystal display (LCD) or an organic electro-luminescence (EL) display, an audio output apparatus such as a speaker or a headphone, or a vibrator. The output apparatus 917 outputs a result obtained through a process performed by the information processing apparatus 900, in the form of video such as text and an image, sounds such as voice and audio sounds, or vibration.

The storage apparatus 919 is an apparatus for data storage that is an example of a storage unit of the information processing apparatus 900. The storage apparatus 919 includes, for example, a magnetic storage device such as a hard disk drive (HDD), a semiconductor storage device, an optical storage device, or a magneto-optical storage device. The storage apparatus 919 stores therein the programs and various data executed by the CPU 901, various data acquired from an outside, and the like.

The drive 921 is a reader/writer for the removable recording medium 927 such as a magnetic disk, an optical disc, a magneto-optical disk, and a semiconductor memory, and built in or externally attached to the information processing apparatus 900. The drive 921 reads out information recorded on the mounted removable recording medium 927, and outputs the information to the RAM 905. The drive 921 writes the record into the mounted removable recording medium 927.

The connection port 923 is a port used to connect devices to the information processing apparatus 900. The connection port 923 may include a Universal Serial Bus (USB) port, an IEEE1394 port, and a Small Computer System Interface (SCSI) port. The connection port 923 may further include an RS-232C port, an optical audio terminal, a High-Definition Multimedia Interface (HDMI) (registered trademark) port, and so on. The connection of the external connection apparatus 929 to the connection port 923 makes it possible to exchange various data between the information processing apparatus 900 and the external connection apparatus 929.

The communication apparatus 925 is a communication interface including, for example, a communication device for connection to a communication network 931. The communication apparatus 925 may be, for example, a communication card for a local area network (LAN), Bluetooth (registered trademark), or a wireless USB (WUSB). The communication apparatus 925 may also be, for example, a router for optical communication, a router for asymmetric digital subscriber line (ADSL), or a modem for various types of communication. For example, the communication apparatus 925 transmits and receives signals in the Internet or transits signals to and receives signals from another communication device by using a predetermined protocol such as TCP/IP. The communication network 931 to which the communication apparatus 925 connects is a network established through wired or wireless connection. The communication network 931 may include, for example, the Internet, a home LAN, infrared communication, radio communication, or satellite communication.

The imaging apparatus 933 is an apparatus that captures an image of a real space by using an image sensor such as a charge coupled device (CCD) and a complementary metal oxide semiconductor (CMOS), and various members such as a lens for controlling image formation of a subject image onto the image sensor, and generates the captured image. The imaging apparatus 933 may capture a still image or a moving image.

The sensor 935 is various sensors such as an acceleration sensor, an angular velocity sensor, a geomagnetic sensor, an illuminance sensor, a temperature sensor, a barometric sensor, and a sound sensor (microphone). The sensor 935 acquires information regarding a state of the information processing apparatus 900 such as a posture of a housing of the information processing apparatus 900, and information regarding an environment surrounding the information processing apparatus 900 such as luminous intensity and noise around the information processing apparatus 900. The sensor 935 may include a global positioning system (GPS) receiver that receives GPS signals to measure latitude, longitude, and altitude of the apparatus.

The example of the hardware configuration of the information processing apparatus 900 has been described. Each of the structural elements described above may be configured by using a general purpose component or may be configured by hardware specialized for the function of each of the structural elements. The configuration may be changed as necessary in accordance with the state of the art at the time of working of the present disclosure.

### (7. Supplement)

The embodiments of the present disclosure may include, for example, the above-described information processing apparatus, the above-described system, the information processing method executed by the information processing apparatus or the system, a program for causing the information processing apparatus to exhibits its function, and a non-transitory physical medium having the program stored therein.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing apparatus including:

a feature extractor configured to extract a feature of first sensor data provided by a sensor carried or worn by a user;

a matching unit configured to match the feature of the first sensor data and a feature of second sensor data corresponding to the first sensor data, the feature of the second sensor data being associated with given position information; and

a position estimation unit configured to estimate a position of the user on the basis of a result of the matching,

(2)

The information processing apparatus according to (1), wherein the feature extractor is configured to extract a feature of the first sensor data in a time series, and

the matching unit is configured to match the feature of the first sensor data that constitutes the time series and a feature of the second sensor data that is associated with a series of the position information that constitutes a path.

(3)

The information processing apparatus according to (1), wherein the feature of the second sensor data is associated with the position information in accordance with a probability model.

(4)

The information processing apparatus according to (3), wherein the position information defines a state in the probability model,

the probability model includes an observation probability of the feature of the second sensor data in the state, and

the matching unit is configured to match the feature of the first sensor data and the feature of the second sensor data on the basis of the observation probability.

(5)

The information processing apparatus according to (4), wherein the probability model includes a transition probability between the states defined by a time series of the position information,

the feature extractor is configured to extract a feature of the first sensor data in a time series, and

the matching unit is configured to match the feature of the first sensor data that constitutes the time series and a feature of the second sensor data that is associated with a series of the position information that constitutes a path on the basis of the observation probability and the transition probability.

(6)

The information processing apparatus according to any one of (3) to (5 wherein the probability model includes an HMM.

(7)

The information processing apparatus according to any one of (1) to (5), wherein the first sensor data includes data representing a reception state of radio waves.

(8)

The information processing apparatus according to any one of (1) to (6), wherein the first sensor data includes acceleration, angular velocity, or geomagnetism.

(9)

The information processing apparatus according to (8), wherein the feature of the first sensor data includes a result of behavior recognition based on the first sensor data.

(10)

An information processing method including:

extracting a feature of first sensor data provided by a sensor carried or worn by a user;

matching the feature of the first sensor data and a feature of second sensor data corresponding to the first sensor data, the feature of the second sensor data being associated with given position information; and

estimating a position of the user on the basis of a result of the matching.

(11)

A program allowing a processing circuit to realize:

a function to extract a feature of first sensor data provided by a sensor carried or worn by a user;

a function to match the feature of the first sensor data and a feature of second sensor data corresponding to the first sensor data, the feature of the second sensor data being associated with given position information; and

a function to estimate a position of the user on the basis of a result of the matching.

### REFERENCE SIGNS LIST

10 system

11, 13 information processing apparatus

100 input unit

101 acceleration sensor

103 gyro sensor

105 geomagnetic sensor

107 barometric sensor

109 Wi-Fi communication unit

111 manipulation input device

113 positioning device/input device

150, 250, 350 interface

200 processing unit

201 Wi-Fi feature amount extractor

203 sensor data feature extractor

205 matching/position estimation unit

207 position-related. information generator

209 sensor map

213 sensor map learning unit

215 position information acquirer

300 output unit

301 display

303 speaker

305 vibrator

1. An information processing apparatus comprising:
a feature extractor configured to extract a feature of first sensor data provided by a sensor carried or worn by a user;
a matching unit configured to match the feature of the first sensor data and a feature of second sensor data corresponding to the first sensor data, the feature of the second sensor data being associated with given position information; and
a position estimation unit configured to estimate a position of the user on the basis of a result of the matching.

2. The information processing apparatus according to claim 1, wherein the feature extractor is configured to extract a feature of the first sensor data in a time series, and
the matching unit is configured to match the feature of the first sensor data that constitutes the time series and a feature of the second sensor data that is associated with a series of the position information that constitutes a path.

3. The information processing apparatus according to claim 1, wherein the feature of the second sensor data is associated with the position information in accordance with a probability model.

4. The information processing apparatus according to claim 3, wherein the position information defines a state in the probability model,
the probability model includes an observation probability of the feature of the second sensor data in the state, and
the matching unit is configured to match the feature of the first sensor data and the feature of the second sensor data on the basis of the observation probability.

5. The information processing apparatus according to claim 4, wherein the probability model includes a transition probability between the states defined by a time series of the position information,
the feature extractor is configured to extract a feature of the first sensor data in a time series, and
the matching unit is configured to match the feature of the first sensor data that constitutes the time series and a feature of the second sensor data that is associated with a series of the position information that constitutes a path on the basis of the observation probability and the transition probability.

6. The information processing apparatus according to claim 3, wherein the probability model includes an HMM.

7. The information processing apparatus according to claim 1, wherein the first sensor data includes data representing a reception state of radio waves.

8. The information processing apparatus according to claim 1, wherein the first sensor data includes acceleration, angular velocity, or geomagnetism.

9. The information processing apparatus according to claim 8, wherein the feature of the first sensor data includes a result of behavior recognition based on the first sensor data.

10. An information processing method comprising:
extracting a feature of first sensor data provided by a sensor carried or worn by a user;
matching the feature of the first sensor data and a feature of second sensor data corresponding to the first sensor data, the feature of the second sensor data being associated with given position information; and
estimating a position of the user on the basis of a result of the matching.

11. A program allowing a processing circuit to realize:
a function to extract a feature of first sensor data provided by a sensor carried or worn by a user;
a function to match the feature of the first sensor data and a feature of second sensor data corresponding to the first sensor data, the feature of the second sensor data being associated with given position information; and
a function to estimate a position of the user on the basis of a result of the matching.
